(19) United States
(12) Patent Application Publication
(10) Pub. No.: US 2004/0032198 A1
(43) Pub. Date: Feb. 19, 2004

(54) Color picture tube device

(76) Inventors: Hiroshi Sakurai, Takatsuki-shi (JP); Etsuji Tagami, Takatsuki-shi (JP); Yasufumi Wada, Takatsuki-shi (JP); Koji Shimada, Kusatsu-shi (JP)

Correspondence Address: Joseph W. Price, SNELL & WILMER L.L.P., Suite 1200, 1920 Main Street, Irvine, CA, 92614-7230, US

(21) Appl. No.: 10/460,561

(22) Filed: Jun. 11, 2003

(30) Foreign Application Priority Data
Jun. 14, 2002 (JP) JP2002-174926

(51) Int. Cl. H01J 29/70

(52) U.S. Cl. 313/440

(57) ABSTRACT

A color picture tube device in which a lens is generated in an area through which a plurality of electron beams pass, so as to be positioned, in a tube axis direction, between a phosphor screen and an end of a core nearest the electron gun. The lens has a horizontal focusing effect that focuses each of the electron beams in the horizontal scanning direction. Furthermore, an interval between at least the two outermost of the plurality of electron beams is adjusted, so that the interval at a time of the electron beams entering the lens widens as the degree of horizontal deflection by a horizontal deflection coil increases.

This application is based on application no.2002-174926 filed in Japan, the content of which is hereby incorporated by reference.

### BACKGROUND OF THE INVENTION

1. Field of the Invention

The present invention relates to a color picture tube device that deflects a plurality of electron beams emitted from an inline electron gun to display a color image on a phosphor screen.

2. Related Art

In a color picture tube device having an inline electron gun in which cathodes corresponding to the colors red (R), green (G) and blue (B) are aligned in a horizontal scanning direction (hereinafter simply “horizontal direction”), the three electron beams emitted from the electron gun are required to meet at an appropriate position on a phosphor screen (this is referred to as “convergence”). Methods of convergence widely used in the prior art include self-convergence and dynamic convergence.

In self-convergence, convergence is conducted by generating non-uniform deflection magnetic fields for deflecting the electron beams, and this generally involves distorting a horizontal deflection magnetic field and a vertical deflection magnetic field into a pincushion shape and a barrel shape, respectively. That is, by creating differences in the deflection amount of each of the three electron beams as they travel through the deflection magnetic fields, the three electron beams are made to converge throughout the phosphor screen.

In dynamic convergence, the three electron beams are made to converge throughout the phosphor screen by generating a magnetic field (dynamic convergence magnetic field) that dynamically changes the angle of the two side electron beams before the electron beams are deflected, and changing an intensity of the magnetic field according to the deflection amount.

Incidentally, in the field of color picture tube devices, further improvements in resolution, particularly in the horizontal direction, are being sought in response to the rapid improvements in display density and increases in display screen size in recent years.

However, with the self-convergence method, the electron beam spots on the phosphor screen become horizontally narrow and elongated (distorted), particularly in peripheral areas of-the phosphor screen in the horizontal direction, due to the deflection magnetic fields also becoming increasingly distorted with increases in the degree of horizontal deflection, and thus improving resolution in the horizontal direction (hereinafter simply “horizontal resolution”) is proving difficult at present.

On the other hand, in the case of dynamic convergence, it is normally possible to suppress deterioration in horizontal resolution to a greater extent than with self-convergence, because of being able to use uniform magnetic fields having no distortion as deflection magnetic fields. However, the fact remains that the shape of the electron beam spots in horizontally peripheral areas of the phosphor screen become distorted, and thus overall improvements in horizontal resolution are sought.

### SUMMARY OF THE INVENTION

In view of the above issues, an object of the present invention is to provide a color picture tube device that allows for improvements in horizontal resolution, even in the case of self-convergence and dynamic convergence.

The above object is achieved by a color picture tube device in which a plurality of electron beams emitted from an inline electron gun are deflected using a deflection yoke that includes a horizontal deflection coil, a vertical deflection coil and a core, and made to converge on a phosphor screen to display a color image. The color picture tube device includes: a lens generating unit operable to generate a lens in an area through which the electron beams pass, so as to be positioned, in a tube axis direction, between the phosphor screen and an end of the core nearest the electron gun, the lens having a horizontal focusing effect that focuses each electron beam in a horizontal scanning direction; and a beam interval adjusting unit operable to adjust a beam interval between at least the two outermost electron beams, so that the beam interval, at a time of the electron beams entering the lens, widens as a degree of horizontal deflection by the horizontal deflection coil increases.

According to this structure, it is possible to reduce the image magnification of electron beams to the phosphor screen across an entire area of the screen in the horizontal direction (i.e. reduce a spot diameter, in the horizontal direction, of electron beams on the phosphor screen), and as a result distortion can be reduced even in peripheral areas of the phosphor screen in the horizontal direction, and improvements in horizontal resolution achieved.

### BRIEF DESCRIPTION OF THE DRAWINGS

These and other objects, advantages and features of the invention will become apparent from the following description thereof taken in conjunction with the accompanying drawings that illustrate a specific embodiment of the present invention.

In the drawings:

FIG. 1 is a side view showing an outside of a color picture tube device according to an embodiment of the present invention;

FIG. 2 is a perspective view showing an exemplary structure of a deflection yoke of the embodiment of the present invention;

FIG. 3 is a partial cross-sectional view showing an upper half of a cross section that cuts the deflection yoke along a plane which is perpendicular to a horizontal direction (direction of X axis) and includes a tube axis;

FIG. 4 schematically shows the gradual widening of an interval between the two outermost of a plurality of electron beams;

FIG. 5 depicts a structure and an effect of a magnetic lens generated by a quadrupole coil;

FIGS. 6A-6C show an exemplary magnetic flux density distribution of a quadrupole magnetic field when vertical deflection is not conducted;

FIG. 7 depicts an adjustment of the magnetic flux density distribution of a quadrupole magnetic field; and

FIG. 8 depicts a magnetic field generated between both poles of an upper coil and a magnetic field generated between both poles of a lower coil.

### DETAILED DESCRIPTION OF THE PREFERRED EMBODIMENTS

The following description relates to an embodiment of a color picture tube device pertaining to the present invention, with reference to the drawings.

(1) Overall Structure of Color Picture Tube Device

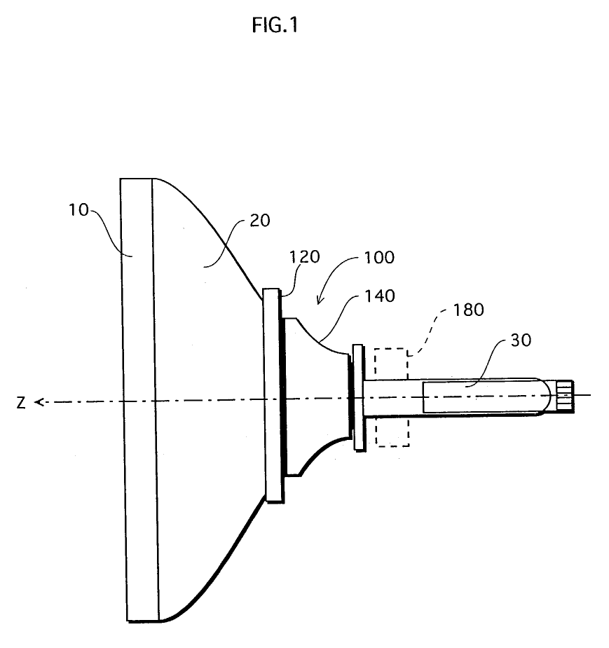

FIG. 1 is a side view showing an outside of the color picture tube device pertaining to the embodiment of the present invention. The color picture tube device includes an envelope constituted by a panel 10 having a phosphor screen formed on an inner surface thereof and a funnel 20, an inline electron gun 30 that is installed within a neck of funnel 20 and emits three electron beams toward the phosphor screen, and a deflection yoke 100 mounted around the outside of funnel 20. In the present embodiment, an electron gun that emits three horizontally aligned electron beams along a tube axis so as to be parallel with each other is used as electron gun 30, the three electron beams being in a substantially parallel state when they enter a horizontal deflection magnetic field. Also, while the following description relates to an arrangement of the electron beams being in the order B, G, R when viewed from the phosphor screen, this arrangement may be altered.

Deflection yoke 100 forms deflection magnetic fields within funnel 20 to deflect the electron beams emitted from electron gun 30.

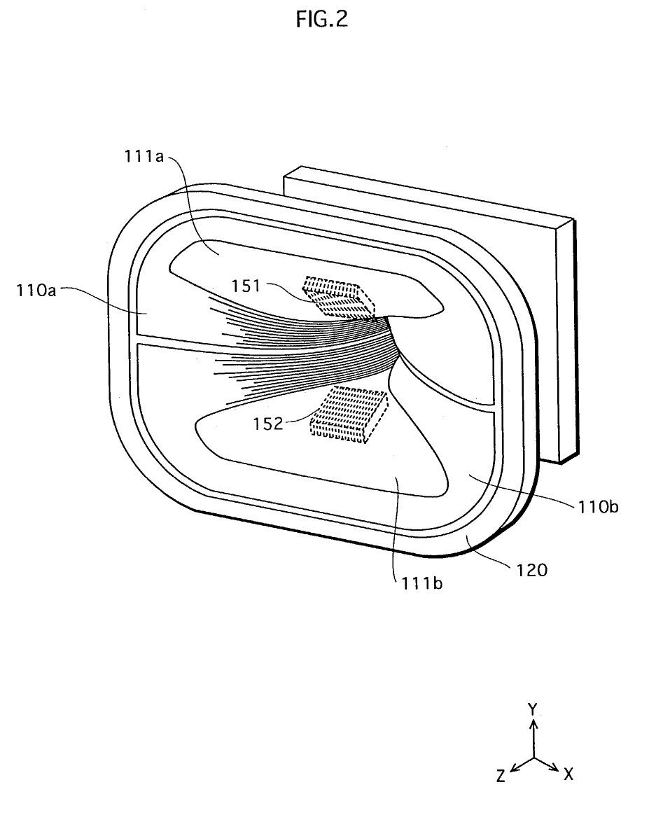

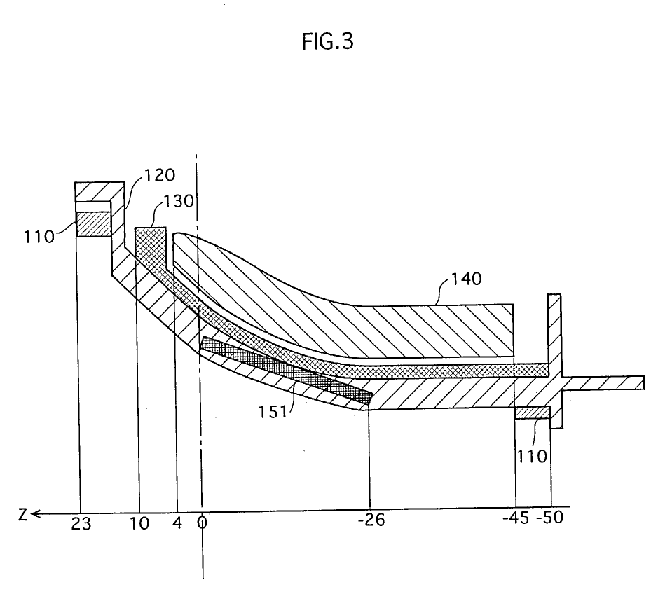

FIG. 2 is a perspective view showing an exemplary structure of deflection yoke 100 of the present embodiment. FIG. 3 is a partial cross-sectional view showing an upper half of a cross section that cuts deflection yoke 100 along a plane which is perpendicular to a horizontal scanning direction (direction of X axis; hereinafter simply “horizontal direction”) and includes the tube axis (Z axis). Deflection yoke 100 is, from a central side (funnel 20 side) to an outer side, structured from a horizontal deflection coil 110, an insulating frame 120, a vertical deflection coil 130, and a ferrite core 140.

Horizontal deflection coil 110 consists of a pair of horizontal coils 110a and 110b formed from a conductor wound into a saddle shape. Horizontal coils 110a and 110b are formed such that respective windows 111a and 111b in a central part thereof face each other, and are disposed so as to follow and contact closely with an inner surface of insulating frame 120. Vertical deflection coil 130, as with horizontal deflection coil 110, consists of a pair of vertical coils formed from a conductor wound into a saddle shape, and ferrite core 140 is provided to encompass vertical deflection coil 130. Ferrite core 140 functions to form a magnetic core or the like with respect to the deflection magnetic fields generated by horizontal deflection coil 110 and vertical deflection coil 130.

In the present embodiment, a coil for generating a lens (in the present embodiment, a magnetic lens generated by a quadrupole magnetic field) is provided in each of widows 111a and 111b. Hereinafter, the coils provided in windows 111a and 111b are referred to respectively as upper coil 151 and lower coil 152. The magnetic lens is formed by upper coil 151 and lower coil 152 (hereinafter referred to collectively as “quadrupole coil” 150), and the three electron beams are converged on the phosphor screen formed on the inner surface of panel 10. A detailed description of the effect of quadrupole coil 150 is given later.

The positioning of the various parts in deflection yoke 100 of the present embodiment will now be described briefly with reference to FIG. 3. In FIG. 3, a position of the front part of quadrupole coil 150 nearest the phosphor screen is set as the reference point (Z=0) along the tube axis, the phosphor screen end being the positive direction and the electron gun end being the negative direction from this reference point. Horizontal deflection coil 110 is located from −50 to 23 (in millimeter units), vertical deflection coil 130 is located from −50 to 10, and ferrite core 140 is located from −45 to 4. The core of quadrupole coil 150 is located from −26 to 0. The core of quadrupole coil 150 has a width of 15 mm, and is embedded in insulating frame 120 in an area of windows 111a and 111b.

A horizontal sawtooth deflection current corresponding to a horizontal deflection frequency is passed through horizontal deflection coil 110. As a result, horizontal deflection coil 110 generates a magnetic field in the vertical scanning direction (hereinafter simply “vertical direction”) within funnel 20, and deflects the electron beams in the horizontal direction. A vertical sawtooth deflection current corresponding to a vertical deflection frequency is passed through vertical deflection coil 130. As a result, vertical deflection coil 130 generates a magnetic field in the horizontal direction within funnel 20, and deflects the electron beams in the vertical direction.

In the present embodiment, a quadrupole magnetic lens is generated by quadrupole coil 150, this lens having a converging effect in the horizontal direction. A magnetic field distribution of the horizontal magnetic field generated by horizontal deflection coil 110 is the same pincushion magnetic field used in a normal self-convergence method. As a result of this magnetic field distribution, the three electron beams, whose interval at a time of entering the lens gradually widens in synchronization with the horizontal deflection, are subjected to the horizontal converging effect of the magnetic lens and converged on the phosphor screen.

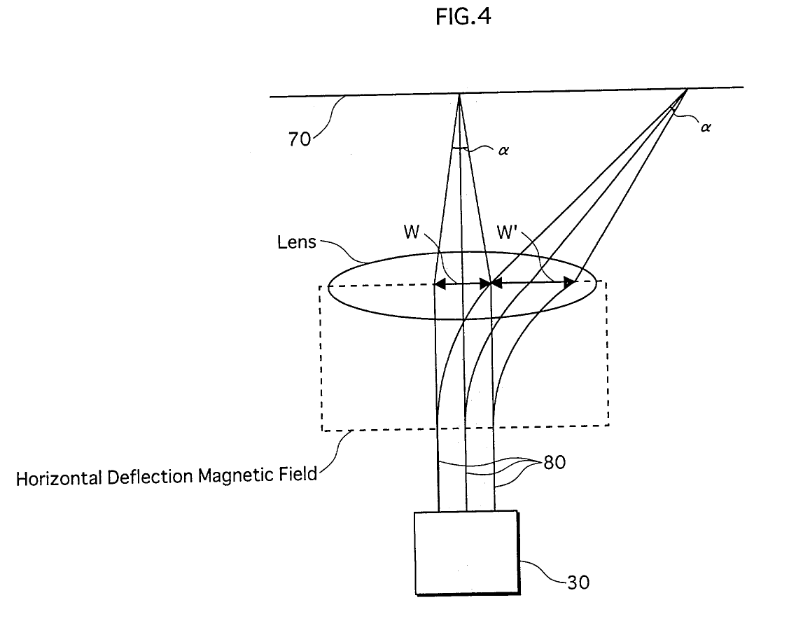

FIG. 4 schematically shows the interval between the three electron beams gradually widening. FIG. 4 is a view from above (i.e. vertical direction) of the paths of the three horizontally aligned electron beams. An interval W (interval between R and B) between the three electron beams 80 emitted from electron gun 30 as shown in FIG. 4 gradually widens as the electron beams are deflected in the horizontal direction (W′>W).

In the present embodiment, horizontal resolution is further improved by gradually widening the interval W of the three electron beams 80 as the electron beams travel from a central part to either side of the horizontal deflection range (i.e. as the degree of horizontal deflection increases).

That is, the magnetic lens functions as a convex lens that makes the three electron beams 80 converge in the horizontal direction (this also involves each electron beam being focused horizontally into a narrow point by the horizontal focusing effect of the magnetic lens).

Generally, in convex lens optics, a relation M=S2/S1 is known to be established when M is the image magnification, S1 is a distance from an object to the lens, and S2 is a distance from the lens to the image. This relation can also be applied to a magnetic lens that functions as the above convex lens, and the relation M=S2/S1 is basically established where, for example, S1 is the distance from the electron gun to the lens and S2 is the distance from the lens to the phosphor screen in the tube axis direction when the electron gun is the object point.

The smaller is image magnification M, the smaller the image, and thus by doing the same with the magnetic lens, and increasing S1 and reducing S2 by bringing the lens nearer the phosphor screen allows for the spot diameter of each electron beam on the screen to be reduced.

The object point is actually the crossover point of the electron beams formed within the electron gun, and since a main lens of the electron gun functions as a convex lens, when a convex lens resulting from the magnetic lens is added, both of these convex lens can be thought of as a composite lens.

Moving the magnetic lens nearer the phosphor screen results in an angle α in FIG. 4 being increased. In other words, image magnification M is reduced when angle α is increased, and the converging power of the magnetic lens in the horizontal direction becomes stronger. Since the horizontal converging power of the magnetic lens (convex lens) has the same effect in relation to each of the electron beams, the focusing power on each electron beam is strengthened when angle α is increased, and results in the spot diameter of each electron beam on the phosphor screen also being reduced in the horizontal direction.

Since the distance from the electron gun to the phosphor screen increases from central to side (both edges) positions in the horizontal direction, if, at the time of horizontal deflection, interval W is the same in a horizontally central position as it is on the sides (i.e. if the interval remains unchanged), angle α will be decreased with increases in the degree of horizontal deflection, and image magnification increased as a result.

Furthermore, since the electron beams are incident upon the phosphor screen at an increasingly oblique angle the further to the side they travel in the horizontal direction, the beam spots becomes horizontally elongated in shape, and since the force that horizontally elongates the beam spots becomes stronger the further to the sides the beams travel as a result of the pincushion magnetic field, distortion in horizontally peripheral areas of the phosphor screen is readily accentuated. Under such conditions, increases in image magnification in horizontal edge positions of the screen leads to distortion in the horizontal direction being further accentuated.

As such, by gradually widening interval W as the degree of horizontal deflection increases, the present embodiment allows for image magnification to be reduced by ensuring that angle α is large even at the horizontal edges of the screen, and as a result horizontal elongation of the beam spots is suppressed, and horizontal resolution is improved by reducing the horizontal spot diameter and further reducing distortion.

As described above, the structure in the present embodiment allows for improvements in horizontal resolution as well as realizing suitable convergence at all positions on phosphor screen surface 70 as a result of interval W between the three electron beams 80 becoming gradually wider.

The magnetic field distribution of the horizontal deflection magnetic field in the present embodiment is set as a pincushion magnetic field used in a normal self-convergence method, and as a result the interval in the horizontal direction gradually widens with increases in the horizontal deflection of the electron beams. As a means of widening the interval between a plurality of electron beams as described above, this structure has the benefit of eliminating distortion in areas above and below a raster when the horizontal deflection magnetic field is a pincushion magnetic field. Here, in the present embodiment, the three electron beams, when incident to an end part of the ferrite core nearest the electron gun, are substantially parallel to one another.

To fine-adjust convergence in peripheral areas of the screen, the distribution of the pincushion magnetic field may be adjusted. If this is insufficient, the quadrupole magnetic lens may be adjusted so that the strength of the horizontal converging effect gradually changes from central to edge positions in the horizontal direction.

While in the present embodiment, quadrupole coil 150 is embedded in insulating frame 120 of the deflection yoke to generate a quadrupole magnetic lens, the image magnification of electron beams to the phosphor screen may, as described above, be reduced by moving a lens having a horizontal converging effect as near as possible to the phosphor screen, and thus allowing for reductions in the horizontal diameter of electron beam spots on the screen and improvements in horizontal resolution, while at the same time widening the interval between the side beams (R,B) in synchronization with the horizontal deflection and realizing convergence at both edges of a phosphor screen in the horizontal direction, as a result of the pincushion magnetic field of the horizontal deflection coil and the horizontal strength distribution of the horizontal converging effect of the lens.

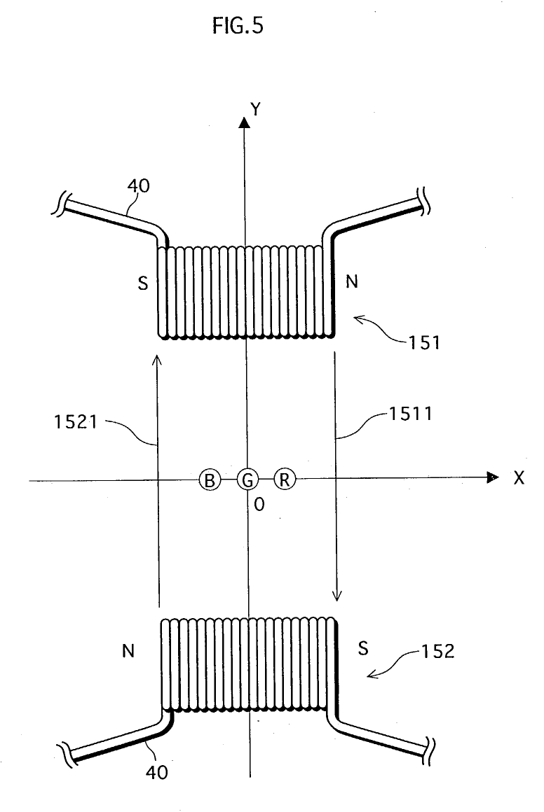

The effect of the quadrupole magnetic lens generated by quadrupole coil 150 will now be described in detail. FIG. 5 shows, as viewed from the phosphor screen, upper coil 151 and lower coil 152, as well as the three electron beams (R,G,B) that pass between these coils. In the present embodiment, upper coil 151 and lower coil 152 are formed by winding a conductor 40 around respective core pieces made of nickel ferrite, and a steady-state current is passed through conductor 40. While the number of winds of the coils may be adjusted arbitrarily, the upper and lower coils both have 100 winds in the present embodiment.

As a result of this structure, magnetic poles are created at both ends of each coil by having the upper and lower coils function as magnet coils, and the quadrupole magnetic field shown in FIG. 5 is generated. The electron beams are subjected to the effect of the horizontal force resulting from a magnetic field 1511 having a vertical component from the north pole of upper coil 151 to the south pole of lower coil 152, and a magnetic field 1521 having a vertical component from the north pole of lower coil 152 to the south pole of upper coil 151.

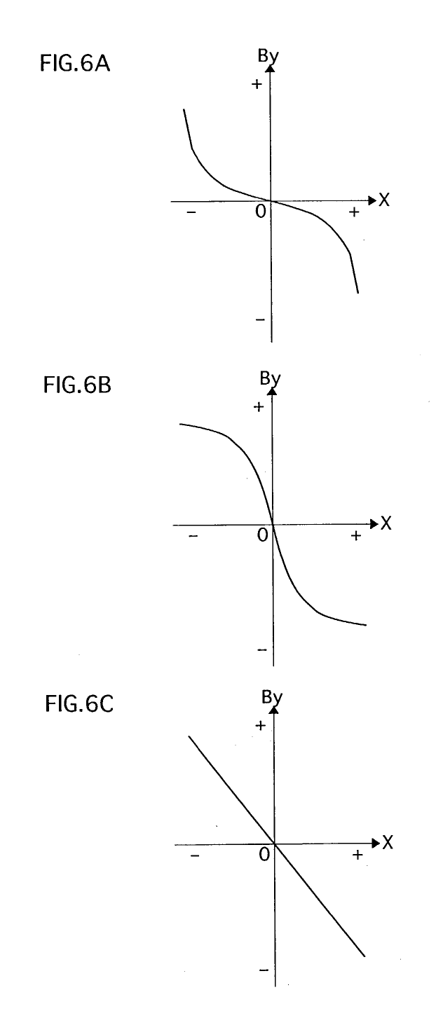

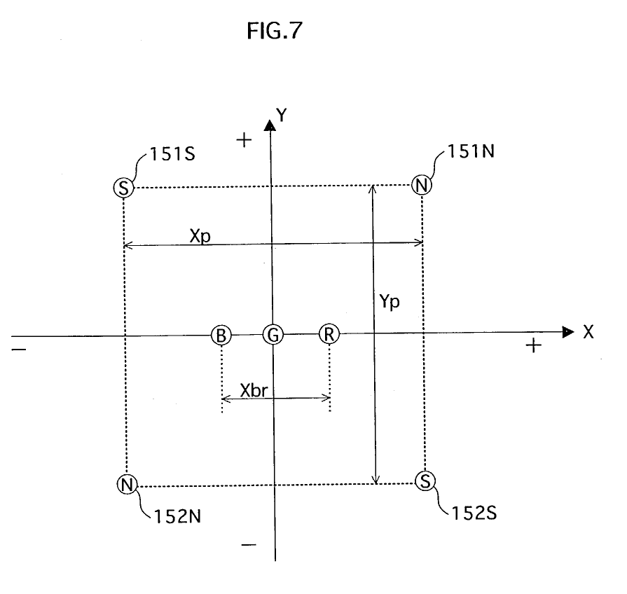

The vertical component of this quadrupole magnetic field has the magnetic flux density distribution shown in FIGS. 6A, 6B and 6C depending on a position in the horizontal direction, where By is the magnetic flux density. The following description relates to adjusting the magnetic flux density distribution in the present embodiment, with reference to FIG. 7. The magnetic flux densities distribution shown in FIGS. 6A to 6C can be selected by adjusting the positional relationship of the four poles of the upper and lower coils shown in FIG. 7; that is, a north pole 151N and a south pole 151S of upper coil 151 and a north pole 152N and a south pole 152S of lower coil 152.

For example, under conditions in which a width Xp and a length Yp of quadrupole coil 150 in the horizontal and vertical directions, respectively, are greater than an interval Xbr between side beams (B,R) in FIG. 7, the distribution shown in FIG. 6A is realized when Xp is large and Yp is small. Conversely, the FIG. 6B distribution is realized when Xp is small and Yp is large. The FIG. 6C distribution is realized when a value of both Xp and Yp is suitably adjusted while being kept substantially equal.

Here, X indicates a horizontal displacement from the tube axis in the distributions shown in FIGS. 6A to 6C. The peak absolute values of the magnetic flux density are in areas in the X-axis direction not shown in FIGS. 6A to 6C. These two peaks are adjusted to be in positions outside of areas through which the three electron beams pass, and the position through which the three electron beams pass between these peaks varies depending on the deflection effect.

With respect to all of these distributions, when there is no deflection effect from the horizontal deflection magnetic field (i.e. when the central electron beam (G) of the three electron beams is in a horizontally central position as shown in FIG. 5), the center of the central electron beam (G) corresponds to the distribution X=0 shown in FIGS. 6A to 6C, and is thus not subjected to the influence of the quadrupole magnetic field. On the other hand, both side beams (B,R) are subjected to a force that brings the side beams nearer the central beam due to the vertical components of the quadrupole magnetic field, which have substantially the same intensity and opposite polarity. Thus the three electron beams are subjected to a converging effect in the horizontal direction and made to converge. That is, a magnetic lens having the above converging effect is generated by the quadrupole magnetic field.

Consequently, when designing the quadrupole magnetic field, first the intensity (equates to the slope in the FIGS. 6A-6C graphs) of a central part of the quadrupole magnetic field is designed such that the three electron beams converge around a central area of the phosphor screen. When electron beams are deflected horizontally, the electron beams need to be made to converge in horizontally peripheral areas of the phosphor screen distant from the center.

As such, in the present embodiment, the distribution of the horizontal deflection magnetic field resulting from the horizontal deflection coil is set to be a pincushion magnetic field, and as a result of this deflection magnetic field distribution and the horizontal converging effect of the magnetic lens, it is possible to reduce image magnification and achieve improvements in resolution and convergence in horizontally peripheral areas of the phosphor screen, while at the same time widening the horizontal interval between both side electron beams (B,R) as the degree of horizontal deflection increases, and have the three electron beams converge at points distant from the phosphor screen center.

Here, when even more rigorous convergence is required, the distribution of the quadrupole magnetic field can be adjusted. The following description relates to this adjustment.

While the three electron beams are subjected to the converging effect of the quadrupole magnetic field that makes them approach one another, even when horizontally deflected, this quadrupole magnetic field is nearer the phosphor screen than an electron gun end of the deflection magnetic field area, and thus the position of the three electron beams in the quadrupole magnetic field varies depending on the deflection amount. That is, because the position of the three electron beams passing through the quadrupole magnetic lens shifts in the horizontal direction, the intensity (slope of FIGS. 6A-6C graphs) of the quadrupole magnetic lens at horizontal positions through which the electron beams pass also varies according to the degree of horizontal deflection.

Here, when convergence is viewed rigorously, it is necessary to have, as the intensity distribution of the quadrupole magnetic field, a distribution in which the converging effect strengthens from central to side areas of the phosphor screen in the horizontal direction, in the case of there being a tendency for the interval between the electron beams to widen when the three electron beams reach the phosphor screen at increasing degrees of horizontal deflection (FIG. 6A distribution).

Conversely, it is necessary to have, as the intensity distribution of the quadrupole magnetic field, a distribution in which the converging effect weakens from horizontally central to side areas of the phosphor screen, when there is a tendency for the point at which the three electron beams converge to move nearer the electron gun from the phosphor screen as the degree of horizontal deflection increases (FIG. 6B distribution).

In cases in which the above adjustments are not required, the intensity distribution of the quadrupole magnetic field may have a converging effect of regular strength from horizontally central to side areas of the phosphor screen, and thus the FIG. 6C distribution is acceptable.

As a result of this structure, it is possible to have the electron beams converge precisely from central to horizontally peripheral parts of the phosphor screen, as well as it being possible to improve resolution in the horizontal direction.

While it is possible to vary the converging effect by synchronizing the intensity of the quadrupole magnetic field with the horizontal deflection, the high horizontal deflection frequency results in a number of undesirable effects such as increases in power consumption and circuit load. According to the present invention, it is possible to achieve improvements in resolution and convergence using a simple structure, without requiring a structure that allows for the converging effect to be varied using horizontal deflection synchronization.

As described above in the present embodiment, by using a pincushion magnetic field as the horizontal deflection magnetic field and generating a magnetic lens that is positioned between the phosphor screen and the electron gun end of the ferrite core of the deflection yoke in the tube axis direction, and provides a plurality of electron beams with a converging effect in the horizontal direction, and thus widening the interval between at least the outermost beams of a plurality of electron beams following horizontal deflection, it is possible to obtain excellent convergence, as well as improving resolution in the horizontal direction from horizontally central to peripheral parts of the phosphor screen.

Here, although in the present embodiment a detailed description of the workings of the vertical deflection effect has been omitted, correspondence is fundamentally possible by adjusting the magnetic field distribution of a conventional vertical deflection coil. More specifically, it is possible to adjust the magnetic field distribution of the vertical deflection coil so that the barrel magnetic field is strengthened. When this alone is insufficient, the structure is preferably one in which the converging effect of the magnetic lens in the horizontal direction weakens depending on the intensity of the vertical deflection magnetic field. More specifically, it is possible to change the converging effect of the magnetic lens in the horizontal direction in synchronization with the vertical deflection. Since the vertical deflection frequency is low at around a few dozen hertz, varying the converging effect in synchronization with the vertical deflection can be easily realized without high power consumption, a complex circuitry structure, or the like. Also acceptable is a structure having a lens strength distribution in which the converging effect in the horizontal direction weakens from central to vertically peripheral areas of the phosphor screen.

Variations

While the present invention has been described above based on the embodiment, the content of the present invention is, of course, not limited to the specific examples given in the above embodiment, and variations such as those described below are considered acceptable.

(1) Although in the above embodiment a pincushion magnetic field is used as the horizontal deflection magnetic field distribution of the horizontal deflection coil, as a means (beam interval adjusting unit) of widening the interval between the three electron beams following horizontal deflection, as long as the same effects can be achieved, it is not absolutely necessary to use a horizontal deflection magnetic field distribution.

For example, it is possible to provide an angle adjusting unit that is positioned between the electron gun and the end of the core nearest the electron gun in the tube axis direction of the deflection yoke, and bends at least the outermost electron beams, with respect to the central electron beam of the plurality of electron beams, so that the interval between the beams widens in the horizontal direction.

More specifically, by, for example, providing, as the angle adjusting unit, a magnetic field generating unit 180 (broken lines in FIG. 1) that generates a magnetic field (dynamic convergence magnetic field) which changes the angle of the two outermost electron beams before the electron beams are deflected, and changing an intensity of the magnetic field depending on the amount of horizontal deflection, as in the case of dynamic convergence, it is possible to widen the interval between the three electron beams together with the horizontal deflection, and easily realize convergence in horizontally peripheral areas of the phosphor screen, while at the same time improving horizontal resolution across an entire surface of the phosphor screen.

In this case, the horizontal deflection magnetic field distribution of the horizontal deflection coil is not limited to the pincushion magnetic field described in the above embodiment, and depending on the effect of the dynamic convergence magnetic field, the intensity of the pincushion magnetic field may be weakened, or a uniform magnetic field distribution or a barrel magnetic field employed, to thus achieve comprehensive design that takes account of other characteristics.

In other words, if the interval between the two outermost beams at a time of entering the magnetic field lens can be widened as the degree of horizontal deflection increases, it is possible to reduce image magnification even at the edge of the phosphor screen, and thus improve horizontal resolution.

(2) Furthermore, although coils for generating a quadrupole magnetic field are provided in the above embodiment, it is also possible to use a magnet for generating a quadrupole magnetic field in cases in which modulating the intensity of the magnetic field in synchronization with the vertical deflection is not necessary. In this case, it is preferable to use a magnet having a small temperature coefficient and stable magnetic characteristics, such as one, for example, formed by mixing a resin with alnico (an Al, Ni, Co alloy). Also, a conductor may be wound around the magnet to form a coil, and the coil used to conduct fine adjustment.

(3) Furthermore, although in the above embodiment two coils are disposed above and below the area through which the electron beams pass in order to generate a quadrupole magnetic field, the present invention is not limited to this, and as alternative structures that allow a quadrupole magnetic field to be generated, it is possible, for example, to dispose two coils in positions to the right and left of the area through which the electron beams pass, or to position four coils diagonally in relation to the electron beams. Also, sextupole or octupole magnetic fields may be used instead of a quadrupole magnetic field. In all of these cases, however, it is of course necessary for the magnetic poles to be disposed so as to generate a force that makes the three electron beams converge in the horizontal direction.

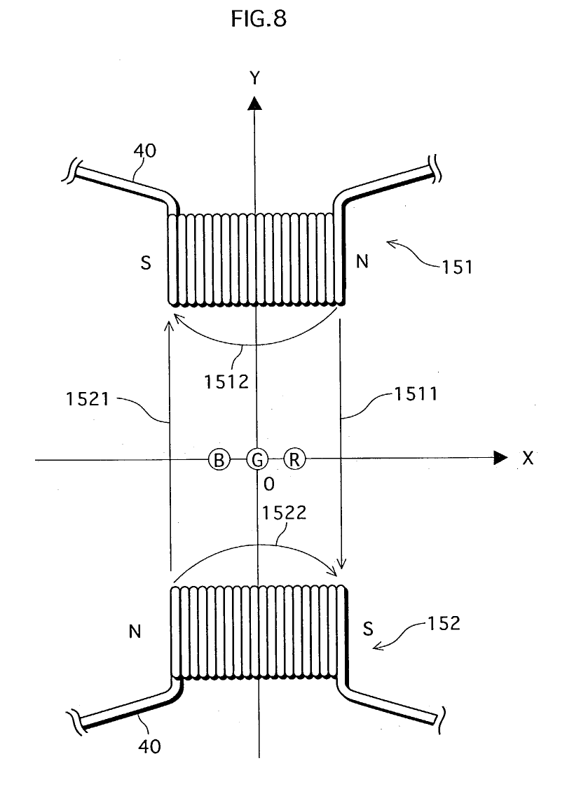

(4) As described briefly above, it is fundamentally possible to improve convergence in relation to vertical deflection of electron beams, by adjusting the intensity of a lens through intensity adjustment of the quadrupole magnetic field or by adjusting the deflection magnetic field of a vertical deflection coil. However, as shown in FIG. 8, when more rigorous convergence is demanded, there are times at which the deflection effect on the electron beams by magnetic field 1512 generated between both poles of upper coil 151 and magnetic field 1522 generated between both poles of lower coil 152 cannot be completely eliminated simply by adjusting lens intensity or adjusting the deflection magnetic field of the vertical deflection coil. That is, where there is an upward deflection effect on the electron beams resulting from magnetic field 1512 and a downward deflection effect on the electron beams resulting from magnetic field 1522, differences in the strength of these deflection effects on each of the three electron beams can lead to parts that cannot be fully compensated for by adjusting the lens strength, the magnetic field distribution of the vertical deflection magnetic field, and the like, and thus causing misconvergence in rigorous terms. Consequently, when the deflection effect of the magnetic field cannot be completely eliminated, a mechanism may be provided that cancels or mitigates magnetic fields 1512 and 1522 in synchronization with the vertical deflection.

(5) Although in the above embodiment electron gun 30 is used to emit three electron beams substantially parallel to one another, the present invention is not limited to this, and the two side beams may be emitted so as to be inwardly angled, or conversely so as to be outwardly angled. In the case of there being no deflection effect from the deflection coils, however, it is necessary to compensate for an amount that the two side beams are subjected to the converging effect of the lens in the horizontal direction and bent inwardly, and angle the beams outwardly before they enter the magnetic lens.

Consequently, in the case of electron guns commonly used, in which the side beams are emitted so as to be inwardly angled and, when there is no deflection effect from the deflection coils, made to converge at a substantially single point in a central part of a phosphor screen, the flight path of the electron beams may be corrected using, for example, a simple magnetic field (“magnetic field” here being distinct from the “deflection magnetic field”) generating device called a convergence yoke and widely used, and as a result the amount that the two side beams are bent inwardly by the converging effect of the magnetic lens in the horizontal direction can be compensated for.

(6) Although in the above embodiment quadrupole coil 150 is provided within deflection yoke 100 to form a quadrupole magnetic lens, the position in which the magnetic lens is provided need not overlap with the deflection magnetic field, and thus a lens may be generated in a position nearer the screen than deflection yoke 100.

(7) Although in the above embodiment a magnetic lens is used as a lens to converge the electron beams in the horizontal direction, the lens is not limited to only a magnetic lens, and it is possible, for example, to have a structure that includes an electrostatic lens. In a structure in which, for example, a known color-selection electrode (shadow mask, etc.) and a known internal magnetic shield that encloses an area within funnel 20 through which the three electron beams pass and is for shielding the magnetic field from external terrestrial magnetism and the like, it is possible to form an electrostatic lens by generating a predetermined potential difference between the color-selection electrode and the internal magnetic shield.

(8) Although the above embodiment was described in relation to using a single magnetic lens, the lens may be divided into two or more parts in the tube axis direction, and this further improves the degree of design freedom. In particular, it is possible to adjust convergence and raster distortion in relative independence of one another by putting at least one of these parts within a core of the deflection yoke and generating at least one of the remaining parts in a position outside of the core and up to the phosphor screen, thus allowing design for both adjustments to be readily conducted.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A color picture tube device in which a plurality of electron beams emitted from an inline electron gun are deflected using a deflection yoke that includes a horizontal deflection coil, a vertical deflection coil and a core, and made to converge on a phosphor screen to display a color image, comprising:
a lens generating unit operable to generate a lens in an area through which the electron beams pass, so as to be positioned, in a tube axis direction, between the phosphor screen and an end of the core nearest the electron gun, the lens having a horizontal focusing effect that focuses each electron beam in a horizontal scanning direction; and
a beam interval adjusting unit operable to adjust a beam interval between at least the two outermost electron beams, so that the beam interval, at a time of the electron beams entering the lens, widens as a degree of horizontal deflection by the horizontal deflection coil increases.

2. The color picture tube device of claim 1, wherein a strength of the horizontal focusing effect of the lens changes depending on the degree of horizontal deflection.

3. The color picture tube device of claim 1, wherein the lens has the horizontal focusing effect, at least when the electron beams are not deflected by a deflection effect of the vertical and horizontal deflection coils.

4. The color picture tube device of claim 1, wherein a position at which each electron beam passes through the lens moves in the horizontal scanning direction in response to a horizontal deflection effect of the horizontal deflection coil.

5. The color picture tube device of claim 1, wherein the lens has a lens strength distribution in which a strength of the horizontal focusing effect gradually changes from a center to a periphery of the phosphor screen in the horizontal scanning direction.

6. The color picture tube device of claim 5, wherein the strength of the horizontal focusing effect gradually increases from the center to the periphery of the phosphor screen in the horizontal scanning direction.

7. The color picture tube device of claim 1, wherein the horizontal deflection coil generates a deflection magnetic field distribution that is a pincushion magnetic field.

8. The color picture tube device of claim 7, wherein the pincushion magnetic field is used as at least part of the beam interval adjusting unit.

9. The color picture tube device of claim 1, wherein at a position corresponding to the end of the core nearest the electron gun in the tube axis direction, the electron beams are each substantially parallel with the tube axis, at least when the electron beams are not deflected by a deflection effect of the vertical and horizontal deflection coils.

10. The color picture tube device of claim 1, comprising:
an angle adjusting unit disposed between the electron gun and the end of the core nearest the electron gun in the tube axis direction, and operable to bend at least the two outermost electron beams with respect to a central electron beam, so that a beam interval therebetween widens in the horizontal scanning direction.

11. The color picture tube device of claim 10, wherein the angle adjusting unit adjusts an angle of the bending by generating a magnetic field.

12. The color picture tube device of claim 10, wherein the angle adjusting unit is used as at least part of the beam interval adjusting unit.

13. The color picture tube device of claim 1, wherein the lens is structured from a plurality of lenses.

14. The color picture tube device of claim 1, wherein at least part of the lens is a magnetic lens.

15. The color picture tube device of claim 1, wherein at least part of the lens generating unit is constituted by a magnet coil.

16. The color picture tube device of claim 1, wherein at least part of the lens generating unit is constituted by a magnet.
